(19) United States
(12) Patent Application Publication
(10) Pub. No.: US 2026/0048475 A1
(43) Pub. Date: Feb. 19, 2026

(54) METHOD FOR MONITORING THE CONDITION OF A HARD FINISHING MACHINE, IN PARTICULAR A GRINDING MACHINE

(71) Applicant: KAPP NILES GmbH & Co. KG, Coburg (DE)

(72) Inventors: Jan SENFTLEBEN, Coburg (DE); Christopher GOEBEL, Ahorn (DE); Johannes RITZ, Sonnefeld (DE)

(21) Appl. No.: 19/300,341

(22) Filed: Aug. 14, 2025

(30) Foreign Application Priority Data
Aug. 19, 2024 (DE) 10 2024 123 554.3

(51) Int. Cl. B24B 49/00; B23F 23/00

(52) U.S. Cl. CPC B24B 49/006; B23F 23/00

(57) ABSTRACT

A method for monitoring the condition of a hard finishing machine, in particular a grinding machine, wherein the hard finishing machine has a number of NC-controlled axes which are actuated during the machining of a workpiece, wherein, for the purpose of evaluating the condition of the hard finishing machine, at least one reference run is performed on at least one axis, during which the response of the axis to a drive signal is measured and evaluated. In order to enable improved condition monitoring of the hard finishing machine, the reference run includes a phase in which the axis is accelerated and/or braked.

### CROSS-REFERENCE TO RELATED APPLICATIONS

The present application claims priority of DE 10 2024 123 554.3, filed Aug. 19, 2024, the priority of this application is hereby claimed, and this application is incorporated herein by reference.

### BACKGROUND OF THE INVENTION

The invention relates to a method for monitoring the condition of a hard finishing machine, in particular a grinding machine, wherein the hard finishing machine has a number of NC-controlled axes which are actuated during the machining of a workpiece, wherein, for the purpose of evaluating the condition of the hard finishing machine, at least one reference run is performed on at least one axis, during which the response of the axis to a drive signal is measured and evaluated.

EP 4 130 902 A1 discloses a method for starting up a production machine with position-controlled axes, in which a control device stores a maximum travel range, a maximum travel speed for the axis and a maximum drive power as boundary conditions for an identification run. The identification run is performed using these parameters, during which the relevant parameters are monitored. Identification is based on a model into which the parameters are entered.

EP 3 176 657 A1 discloses a method for determining the stiffness of a drive train for linear movement of a machine component along a linear guide of a machine tool. A constant acceleration is specified for the machine component and a difference between a specified and measured position of the machine component is determined.

WO 2023/061851 A1 discloses a method for monitoring the condition of a machine tool, which can be used to predict the development of disturbing noises in a gearbox, wherein the gearbox contains a workpiece being machined by the machine. In this method, machine spectral data is calculated from machine measurement data by spectral analysis to determine at which frequencies or orders periodic excitations of machine components occur while a machine axis is being operated.

DE 10 2023 101 527 A1 discloses a method for monitoring the condition of an electric drive system, in which process data and drive data are recorded using an identifying feature. This is intended to enable better detection of operating conditions of interest.

A hard finishing machine, in particular a gear grinding or profile grinding machine, is subject to wear and tear during operation, so that machine maintenance must be carried out at appropriate intervals and machine components replaced if necessary. The same applies, for example, in the event of an unexpected event (e.g. crash, overload). It is important to avoid producing workpieces while the machine is no longer in proper working order due to wear or damage.

It is therefore common practice to periodically perform reference runs on the machine to check its status and, in particular, to assess wear, wherein during these runs, the machine axes (linear axes/rotary axes) are moved outside the actual operating range of the machine and the response to specified control signals is recorded. This makes it possible to check whether the machine components involved are still in perfect condition or whether changes in the response to specified control signals have already been detected due to wear or an unexpected event (e.g. crash). In the latter case, appropriate machine maintenance is then required.

The cyclical reference runs provide a very accurate picture of the machine status. Precise results are obtained because the reference runs can be performed with predefined movements under similar conditions, meaning that disruptive factors have only a minimal impact on the system.

However, the disadvantage here is that the frequency with which changes to the machine can be detected depends on the period chosen for the reference runs. In practice, efforts are made not to carry out reference runs too frequently due to the time required (as no workpieces can be machined during these runs), which then leads to relatively long periods during which the machine is not checked (long intervals between reference runs). Longer reference runs can also lead to problems with the machine's temperature curve.

### SUMMARY OF THE INVENTION

The invention is based on the object of further developing a method of the type mentioned above in such a way that improved condition monitoring of the hard finishing machine and, in particular, its machine components, especially the linear and rotary axes, is possible. This should enable close-meshed machine monitoring with as little loss of machine capacity as possible. A further object is to detect possible causes of wear more accurately.

The solution to this problem provided by the invention is characterised in that the reference run comprises a phase in which the axis is accelerated and/or braked, wherein for the assessment of the wear condition of the hard finishing machine the response of the axis to the drive signal is measured and the measured response is compared with expected signal curves, which were present when the axis was in proper condition, wherein a statement is derived from the comparison as to whether the axis is in a proper condition.

Thus, the predetermined reactions mentioned are those that were present when the axis was in proper condition (or were determined when the axis was in proper condition). Combinations of several reactions resulting from a proper condition can also be taken into account. Such reactions may also originate from other machines and have been recorded there.

The comparison is preferably carried out using a machine learning concept or a deep learning concept. Machine learning or deep learning is preferably carried out using at least one autoencoder.

The measured and evaluated response of the axis to the drive signal can be, for example and preferably, a control difference of the NC axis that occurs during control of the machine axis, or can be an acceleration/oscillation recorded by an acceleration sensor, and/or can be a current with which a machine axis is driven. Other signals that provide significant information about the acceleration or deceleration process may also be considered, whereby such signals can be taken into account alternatively or additively.

The reference run takes place preferably when there is no engagement between the tool of the hard finishing machine and the workpiece.

The reference run can comprise, in addition to at least one acceleration phase and/or deceleration phase, a phase of constant speed of the axis.

The reference run can also be performed as a test run, which takes place during a machining phase of the workpiece, beginning with the insertion of the workpiece into the hard finishing machine and ending with the removal of the machined workpiece from the hard finishing machine. In this case, it can be provided that the test run takes place when there is no contact between the tool of the hard finishing machine and the workpiece.

The test run takes place preferably during an idle stroke in which the tool is moved relative to the workpiece without the tool engaging with the workpiece.

With regard to the above comparison of the measured response of the axis to the drive signal with predetermined responses, a preferred embodiment of the invention provides for an assessment of whether it is to be expected that a permissible tolerance band will be exceeded. In this respect, a trend analysis is performed, taking into account previously recorded values, in order to determine whether the machine axis is about to leave a permissible operating range. Artificial intelligence methods are also very well suited for performing this automatically.

The method is preferably used on a gear grinding machine.

This enables efficient evaluation of the wear condition of the machine by evaluating signal curves that are determined when an axis passes through at least one acceleration phase or at least one deceleration phase. The aforementioned acceleration phases or deceleration phases are performed during a reference run or by idle strokes during machine operation. To evaluate the recorded signals, known methods of artificial intelligence, in particular machine learning or deep learning, are preferably used.

The proposed procedure allows for improved detection of machine faults and the current wear status of the machine.

In addition to the known evaluation of constant motion from a reference run, the invention integrates at least one acceleration and/or deceleration phase (from a reference run and/or from idle strokes during the process) into the evaluation. These acceleration and deceleration phases represent non-linearities much better than constant movements, such as those that occur with loose parts or clearance. This allows incipient wear to be detected more quickly and at an earlier stage respectively. In particular, acceleration from a standstill or deceleration to a standstill on linear axes is useful for the correct detection of such errors (non-linearities).

Another advantage is that the more comprehensive evaluation of the reference run allows the entire system, consisting of individual mechanical components of the axis, controller settings, drives, etc., to be assessed as a whole. Among other things, current peaks, sluggishness and lubrication conditions can be detected more effectively during the acceleration phases.

This is particularly important for components with gear teeth for electric mobility due to increased quality requirements and tight workpiece tolerances.

Statistical or characteristic-based approaches are not ideal for evaluating non-linear phases. Due to the complexity of the problem, the entire signal curves and/or combinations of signal curves are advantageous for evaluation. Machine learning or deep learning methods are much more suitable for evaluation. These methods can also detect complex changes in the system.

With regard to the nomenclature used above, it should be noted that a “test run” refers to the described monitoring of a machine axis during the regular machining process of a workpiece—although this only applies to sub-processes of machining in which the tool does not engage with the workpiece—whereas a “reference run” is a separate test run of the (complete) machine axes that is performed outside the machining process of a workpiece.

A test run may be particularly preferred during a dressing phase in which the tool is profiled, and/or during a phase in which the workpiece is aligned for machining in the hard finishing machine, and/or during a phase in which a balancing operation is performed, and/or in a phase in which a loading or unloading operation is performed.

According to the proposed concept, it is possible to record the condition of the machine and, in particular, the machine components during a workpiece machining cycle, thereby enabling close-meshed and time-independent monitoring. Time-consuming reference runs, which are therefore only carried out sporadically, no longer need to be performed cyclically, but can be carried out as required.

The inclusion of at least one acceleration phase or at least one deceleration phase in the evaluation has shown that a much better assessment of the machine status is possible than is the case with the previously known evaluation with constant movement of the machine axis.

The quality of monitoring is improved thanks to the timely close-mesh schedule, and non-productive times can be reduced to a minimum. As a result, the number of workpieces that are not processed correctly (due to worn or faulty machine components) can be reduced. Furthermore, fault cause analysis is made much easier and provides a good basis for preventive machine maintenance and repair (“predictive maintenance” concept).

Another advantage is that causes of sudden wear (such as dirt or other abrasive media entering bearings or ball screw drives, or a crash or overload of the machine) can be identified much more easily and assigned much more accurately.

Another advantage is that the availability of the machine for effective machining of the workpiece can be increased, as downtime that would otherwise be available is used for test runs, thereby reducing or avoiding unplanned machine downtime with the procedure described.

Finally, another advantage is that critical temperature fluctuations in the machine can be avoided.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawings:

FIG. 1 shows the course of a control difference over time during the acceleration of a machine axis of a gear grinding machine, with the new condition (curve a), the onset of wear (curve b) and the worn condition (curve c) indicated,

FIG. 2 shows schematically the structure of an autoencoder which is used for evaluating a detected signal within the “machine learning” concept,

FIG. 3 shows, by way of example, (at the top) the original data input into the autoencoder, (in the middle) the encoded signal and (at the bottom) the decoded signal which was determined by the autoencoder, and

FIG. 4 shows schematically the composition of individual operating phases of the machine into models that can be analysed.

### DETAILED DESCRIPTION OF THE INVENTION

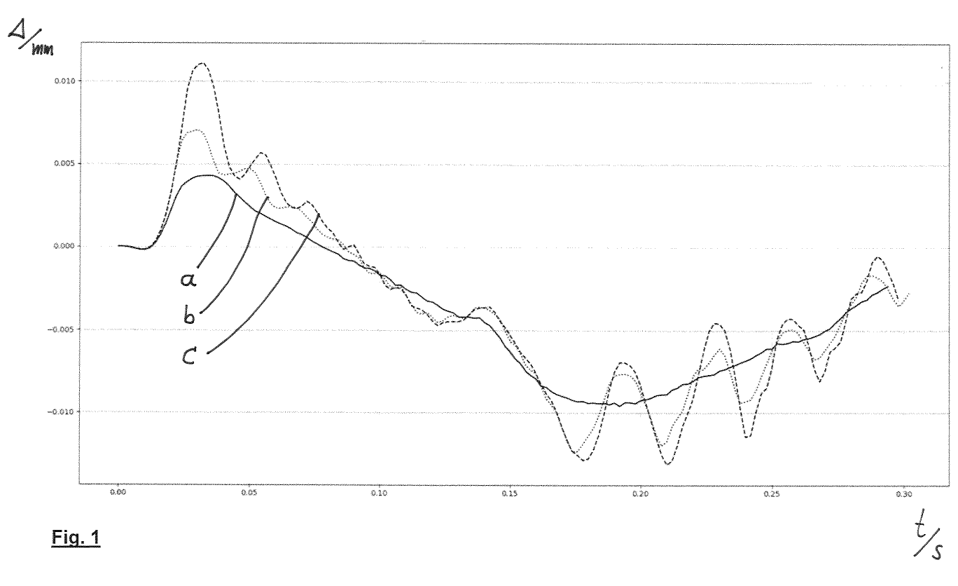

FIG. 1 shows the control difference over time for a machine axis on a gear grinding machine. The control difference is the deviation between the specified movement and the actual movement of the machine axis. As wear progresses (and thus with increasing clearance and increasing sluggishness), it becomes increasingly difficult for the machine control to bring the actual position as close as possible to the desired position. Consequently, the control deviation can be used as a measure of the wear condition of the machine or of those components that influence the movement of the relevant machine axis.

The figure shows the resulting control deviation (in mm) for a period of 0.3 s, during which the machine axis is accelerated from rest at a specified acceleration.

The curve a represents the progression that is achieved when the machine is new. When wear gradually begins in the machine, curve b is produced. When the machine is worn, curve c is finally produced.

It is essential that particularly significant information about the wear condition of the axis can be obtained if, instead of driving at a constant speed (constant speed of the machine axis) as has been the case up to now, the machine axis is subjected to a specified acceleration, as shown, which it must then travel at.

As can be seen from the curves of the control difference over time shown in FIG. 1, the curve pattern allows a fairly accurate statement to be made about the wear condition of the machine.

The evaluation of the captured curve of the control difference over time, i.e. the comparison with previously recorded curves when the machine was new, using statistical methods alone or by means of characteristic values, sometimes does not provide a sufficiently good result.

“Machine learning” or “deep learning” methods are advantageously used to evaluate the changes in the acceleration phase (as shown in FIG. 1) and/or in a deceleration phase.

A preferred method here is the use of an autoencoder. This consists of several specially arranged layers of a neural network with the aim of learning efficient coding, which can be used to detect anomalies. The neural network is trained, for example, with data from reference runs that have been clearly classified as “proper”. If data from a reference run with an unknown status (during the service life of the machine or axis) is then fed into the autoencoder, it attempts to reconstruct the signal based on its previously trained status or the learned coding. Error values (such as “mean absolute error” or “mean squared error”) are calculated between the input and output signals. If certain threshold values of these calculated parameters are exceeded, a message is issued indicating the condition of the axis and that a critical wear condition has been reached. This procedure also allows messages to be issued if a trend change in the machine condition is detected. For example, if several tests within a certain time interval show an increase in defined measured values, this may indicate incipient wear, which can be signalled by the system.

The reference signals can or must be considered separately for different machine series. All algorithms are based on a sufficiently large data set that is sufficiently significant. These data sets are based on a large number of measurement series on machines in the field, in-house and on specially constructed test benches.

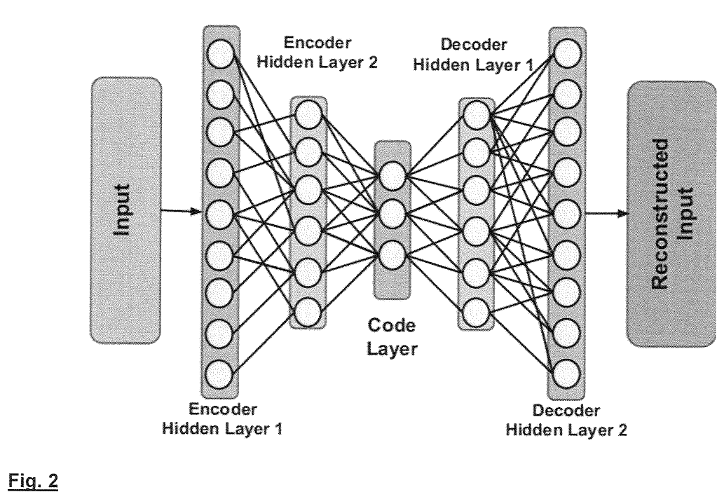

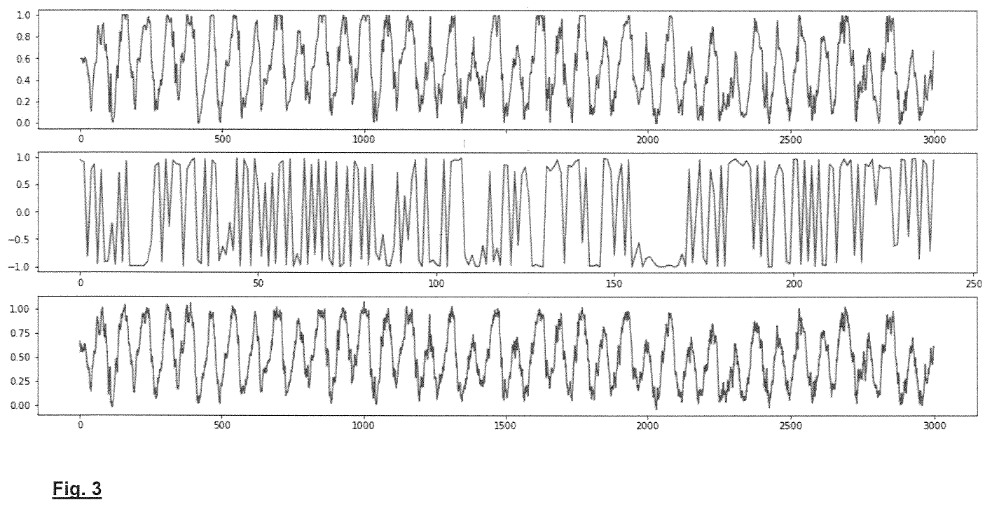

This means that Artificial Intelligence-based evaluations are preferred, as illustrated in FIGS. 2 and 3.

FIG. 2 shows the basic structure of an autoencoder. It provides a schematic overview of how an autoencoder works to obtain a “reconstructed input” based on the “input” values, which allows conclusions to be drawn about the extent to which the input values have changed in relation to the specified values in order to identify any relevant deviations.

The number of neurons (the circular symbols in FIG. 2) are cyclically reduced via an “Encoder Hidden Layer 1′” and an “Encoder Hidden Layer 2” until they reach the “Code Layer”. The encoded signal can be tapped there. From the “Code Layer” to the output layer (“Reconstructed input”), the number of neurons is cyclically increased again by the “Decoder Hidden Layer 1” via the “Decoder Hidden Layer 2”.

FIG. 3 illustrates this using a specific example. The figure shows sample signals at the different “layers”. The input signal (upper depiction in FIG. 3: original data input) is continuously reduced by the “Encoder Hidden Layer” of the neural network in terms of the number of samples until the encoded signal (“Code Layer”) is reached (see middle depiction in FIG. 3: encoded signal). The signal is then converted back to the original number of samples (“upsampled”; lower depiction in FIG. 3: decoded signal) by the “Decoded Hidden Layer”.

In the ideal case, the autoencoder can reconstruct the signal without errors. If signals are fed into the autoencoder that deviate from the form of the learned signals, the autoencoder cannot reconstruct the signal without errors. The calculated error values become larger as the deviation (due to wear) from the input signal increases.

The system can then detect wear in the machine or machine axis and send a corresponding message to the machine operator.

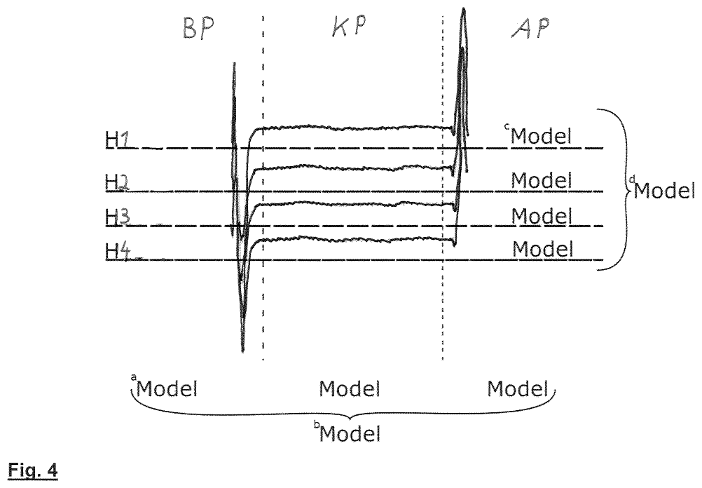

FIG. 4 schematically illustrates how models can be created, which are then used as the basis for the evaluation described above. Shown are several measurement strokes (H1, H2, H3, H4) for one axis of the machine, each of which has an acceleration phase BP, a constant speed phase KP and a deceleration phase AP. Different combinations of the machining components can be used for model formation.

According to “Model a”, the acceleration phase BP, the constant phase KP and the deceleration phase AP are considered and, for modelling purposes, the respective phases of the four strokes are combined or each phase is used individually for a model.

According to “Model b”, the three phases BP, KP and AP are combined into one model.

According to “Model c”, the three phases BP, KP and AP are combined, but considered separately for each stroke.

According to “Model d”, the data for “Model c” is summarised for all strokes (one model for the entire reference run).

Of course, other models or types of neural networks can also be used to perform the monitoring described above.

The procedure described above allows essential information about the machine status to be determined, enabling deviations to be identified very quickly and reliably and appropriate measures to be taken if necessary. This prevents the production of workpieces that are rejects.

Furthermore, a comprehensive concept for preventive machine maintenance (“predictive maintenance”) can be implemented.

This is particularly advantageous in the event of sudden wear, as it allows to quickly identify that machine components need to be replaced, for example. If necessary, the parameters can be extrapolated to predict the optimal time for taking action.

During phases of machining of the workpiece in which the tool does not engage with the workpiece, in particular during tool dressing, balancing, swivelling a rotary table or other machine movements necessary for the machining cycle, data from the individual axis is recorded.

These idle strokes (i.e. machine movements during which the tool does not engage with the workpiece) can include, in particular, an idle stroke during finishing dressing (Y-axis) or rough dressing, the feed during dressing and grinding (X-axis), an idle stroke during grinding (Z-axis) or moving to the starting position for balancing or spinning. The phases of the machining process in which balancing, spinning, aligning the workpiece, swivelling a tower (a rotary table) for dressing and changing the workpiece are also well suited.

The recorded measurement signals may in particular be signals from an acceleration sensor arranged on a component of the machine, control internal signals (such as currents or control differences) and other signals, if necessary, from existing sensors (for example, from a current measuring clamp and a transmitter).

The signals are preferably processed on an industrial PC.

The signal curves, evaluations and analyses can be stored in a database locally on the PC. It is also possible to store and evaluate the data in the cloud.

The proposed concept can be used for specific assemblies, machines or components, or even across multiple machines. An approach covering different machine types is also possible. A sufficient and sufficiently large database is always required for all adjustments to the concept.

While specific embodiments of the invention have been shown and described in detail to illustrate the inventive principles, it will be understood that the invention may be embodied otherwise without departing from such principles.

We claim:

1. A method for monitoring the condition of a hard finishing machine, in particular a grinding machine, wherein the hard finishing machine has a number of NC-controlled axes which are actuated during the machining of a workpiece, wherein, for the purpose of evaluating the condition of the hard finishing machine, at least one reference run is performed on at least one axis, during which a response of the axis to a drive signal is measured and evaluated, wherein the reference run includes a phase in which the axis is accelerated and/or braked, wherein for the assessment of the wear condition of the hard finishing machine the response of the axis to the drive signal is measured and the measured response is compared with expected signal curves, which were present when the axis was in proper condition, wherein a statement is derived from the comparison as to whether the axis is in a proper condition.

2. The method according to claim 1, wherein the comparison is performed using a machine learning concept or a deep learning concept.

3. The method according to claim 2, wherein the machine learning concept or the deep learning concept is used with at least one autoencoder.

4. The method according to claim 1, wherein the measured and evaluated response of the axis to the drive signal is a control difference of the NC axis which occurs during the control of the machine axis, or is an acceleration which is detected by an acceleration sensor, and/or is a current with which a machine axis is driven.

5. The method according to claim 1, wherein the reference run takes place when there is no engagement between the tool of the hard finishing machine and the workpiece.

6. The method according to claim 1, wherein the reference run comprises, in addition to at least one acceleration phase and/or deceleration phase, a phase of constant speed of the axis.

7. The method according to claim 1, wherein the reference run is performed as a test run which takes place during a processing phase of the workpiece, which begins with the entry of the workpiece into the hard finishing machine and ends with the removal of the machined workpiece from the hard finishing machine.

8. The method according to claim 7, wherein the test run is performed when there is no engagement between the tool of the hard finishing machine and the workpiece.

9. The method according to claim 8, wherein the test run takes place during an idle stroke in which the tool is moved relative to the workpiece without the tool engaging with the workpiece.

10. The method according to claim 1, wherein, when comparing the measured response of the axis to the drive signal with predetermined responses, an assessment is made as to whether it is to be expected that a permissible tolerance band will be exceeded.

11. The method according to claim 1, wherein the method is used on a gear grinding machine.
